(19) United States
(12) Patent Application Publication
(10) Pub. No.: US 2013/0068118 A1
(43) Pub. Date: Mar. 21, 2013

(54) SHOE STICKER INK STAMP UNIT

(71) Applicant: Douglas H. Bartow, Greenville, SC (US)

(72) Inventor: Douglas H. Bartow, Greenville, SC (US)

(21) Appl. No.: 13/237,242

(22) Filed: Sep. 20, 2011

(51) Int. Cl. B05C 17/06; B41M 1/12

(52) U.S. Cl. 101/127; 101/129

(57) ABSTRACT

An ink sticker stamp unit to be affixed to a bottom of a shoe for reproducing an imprint of a design while walking comprising a bottom stencil layer, a stencil with one or more cutouts to reproduce the design; an ink applicator layer disposed above the stencil layer for retaining and supplying ink through the stencil cutouts when walking; securing means for securing the bottom stencil layer and the ink applicator together, and affixing means for removably affixing the ink applicator layer to a bottom of the shoe.

### BACKGROUND OF THE INVENTION

The invention relates to the art of printing distinctive and non-distinctive designs, including words, logos, names, sponsors, and other markings and indicia, on surfaces and, particularly, to an attachable ink sticker stamp unit to be worn on an individual's shoe to imprint the design upon a surface while walking.

With the increased interest in professional and college sports teams, advertising, advertising slogans and increased use of distinctive markings, logos, graphics, and text in schools, colleges, business services, parades, and politics, entertainers, and artists, etc., a simple and reliable device to imprint designs while walking to events and the like would be an advantageous manner of display, or simply children imprinting designs at home on a patio or driveway while playing.

Mass shoe manufacturers have no means for customizing their footwear soles to provide an individual customer's custom design incorporated as a pattern to the bottom of the sole.

Prior printing devices are known that can print a design, e.g. text, graphics, and/or other indicia, on a ground surface. The desired design is printed on the ground surface when the printing device is applied to the bottom of the footwear sole and the individual is walking. The ground surface may be either a soft impressionable surface or a hard surface which is stamped with ink.

The following patents include graphic or letter plates worn by a shoe to print on a soft surface such as soil, sand, snow, etc. Published Application US 2010/0083536 A1 shows a graphic imprint plate that is removable and interchangeable in the bottom of a shoe, mainly on soft surfaces. Published Application US 2002/0166258 A1 shows footwear for leaving a personalized imprint in wet sand or other surfaces. U.S. Pat. No. 5,822,885 discloses footwear having a bottom surface embossed with three dimensional representations that are imprinted on soft walking surfaces. U.S. Pat. No. 5,331,753 discloses an article of footwear for printing personalized messages on a ground surface. The bottom of the shoe has a special track built into the sole which receives inserts with a symbol by which a person may originate his personal design to be imprinted. U.S. Pat. No. 4,958,446 discloses footwear having a bottom design for imprinting advertising messages into sandy soil. U.S. Pat. No. 4,050,168 discloses an attachment having a raised symbol which may be mounted to the sole of a shoe for imprinting the symbol in soft ground.

The following patents include using ink to imprint a design made into or secured to the sole of a shoe. U.S. Pat. No. 438,179 shows printing blocks that ratchet between an ink pad and a printing position against the sidewalk, etc. U.S. Pat. No. 6,497,056 discloses personalized patterns for footwear soles that include a stamp pad and an ink reservoir connected by a tube in a rather awkward construction. The ink is stamped onto a surface. U.S. Pat. No. 5,586,501 discloses disappearing ink in a marking system which includes ink tubes for supplying ink to pads to impress the advertisement on the surface of a walk or floor. EP 0171697 discloses a printing means responsive to a pressure exerted vertically on a sole of a shoe to imprint a pattern on the ground or walk. Printing portions in the sole open to the ground normally do not print the pattern of the printing portions unless downward vertical pressure higher than that of normal is placed upon the shoe sole.

The prior art of ink stamping footwear has typically involved ink reservoirs requiring delivery tubes to deliver ink to the imprint, or otherwise are relatively awkward and relatively complicated considering the result to be achieved. The printing head mechanisms have not been satisfactory for a true attachable printing device that can be purchased and affixed to a shoe sole, for example one that can be sold and purchased at sporting goods stores and events, or other stores, and worn while walking to and at a sports events, or other public events, or a home driveway or patio.

### SUMMARY OF THE INVENTION

An ink sticker stamp unit to be carried by a shoe is provided for producing an imprint of a design on a walking surface comprising a bottom stencil having one or more stencil cutouts corresponding to the design. An ink applicator is disposed above the stencil for applying ink directly through the stencil cutouts reproducing an imprint of the design. An adhesive layer is disposed above the ink applicator for affixing the unit to the shoe so that pressure applied by the shoe on the ink applicator while walking causes ink to flow through the stencil cutout to imprint the design on the walking surface. The device includes a seal carried by the stencil around perimeter edges of one or more cutouts to prevent the ink from seeping onto the stencil as ink is squeezed through the cutouts. An adhesive layer is disposed between the ink applicator layer and stencil wherein the adhesive layer does not cover the stencil cutouts. A method of producing imprints of a design while walking according to the invention comprises the steps of providing an ink stamp sticker having an upper adhesive layer, a bottom stencil having stencil cutouts corresponding to the design, and a source of ink disposed between the adhesive layer and stencil; affixing the stamp sticker to the bottom of the shoe so that the stencil is exposed to the ground surface; and walking with the stamp sticker affixed to the shoe to reproduce imprints of the design. A removable, adhering layer covers the stencil or cutouts to prevent ink drying before use, or the unit may simply be included in the package.

Advantageously, the stick on/peel off system does not require modifications to a shoe nor does it change the outward appearance of the shoe. The stick on/peel off system and method does not change the shoe or other application tool so they can be reused with the disposable ink pads. This system and method uses pre-wetted disposable pads which deliver a constant ink feed through applied pressure. It requires no mechanical rewetting such as prior art stamps by means of rotating rubber stamps mechanically to an ink reservoir or manually pressing the rubber stamp to an ink pad and next to the surface to be stamped. The disposable nature of this constant feed ink stamp allows it to be selected for the best application using a variety of shapes, colors and ink types, e.g., used on a shoe in public places or areas where the image is intended to be temporary. The ink pad is water based and easily removed by water washing or rain. Also, disappearing ink can be used. A luminescence agent can be added to the ink for “glow in the dark” images. All types of ink can be applied with this device such as temporary “washable” ink, permanent ink, disappearing ink, multi-colored ink on same pad, glow in the dark ink, glitter ink, and combinations of above, etc. Used as a permanent design imprint, such as adding designs to cement floors, commercial or residential walls, ceilings, artwork, etc. The ink can be permanent ink. Due to the constant feed and no requirement for re-inking the pad, the imprints are very consistent until such time as the ink runs out.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a bottom perspective view of a shoe sole to which an ink sticker stamp unit has been attached according to the invention;

FIG. 2 is a perspective illustration of a person imprinting a design or text on the ground as they walk to a sporting event;

FIG. 3 is a perspective view of the ink sticker stamp unit constructed according to the invention;

FIG. 4 is a perspective view of a shoe sticker stamp unit wherein a release liner is shown removed to expose the adhesive layer that affixes the sticker stamp to the shoe sole;

FIG. 5 is a bottom plan view of an ink sticker stamp unit according to the invention illustrating a stencil of the stamp;

FIG. 6 is an enlarged sectional view taken along line 6-6 of FIG. 5 illustrating the various layers of an ink stamp sticker unit according to the invention;

FIG. 7 is a bottom view perspective illustrating a multi-color ink sticker stamp according to the invention for imprinting different colored designs;

FIG. 8 illustrates an example of a multi-color tiger paw design for an ink sticker stamp according to the invention;

FIG. 9A illustrates an example of a multi-color design for a Budweiser racing car design for an ink sticker stamp according to the invention;

FIG. 9B illustrates an example of a multi-color pink ribbon and Komen design for an ink sticker stamp according to the invention which can be used during fund raising parades.

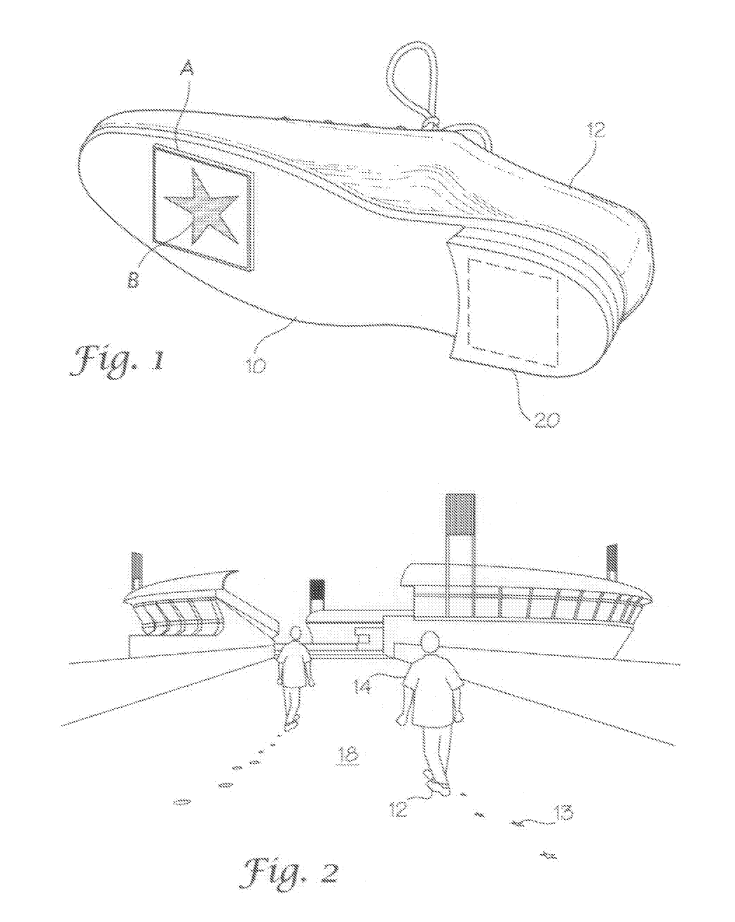

### DESCRIPTION OF A PREFERRED EMBODIMENT

The invention will now be described in more detail by referring to the drawings described above.

FIG. 1 illustrates an ink sticker stamp unit, designated generally as A, which is attached to a sole 10 of a shoe 12 for imprinting a design on a surface while an individual 14, wearing the shoe, is walking, according to the invention. For example, the individual may be attending an event at an outdoor stadium 16 or arena, and imprints a design B on a paved surface 18 while walking to the stadium. Of course the sticker stamp unit may be attached to a heel 20 of the shoe as well.

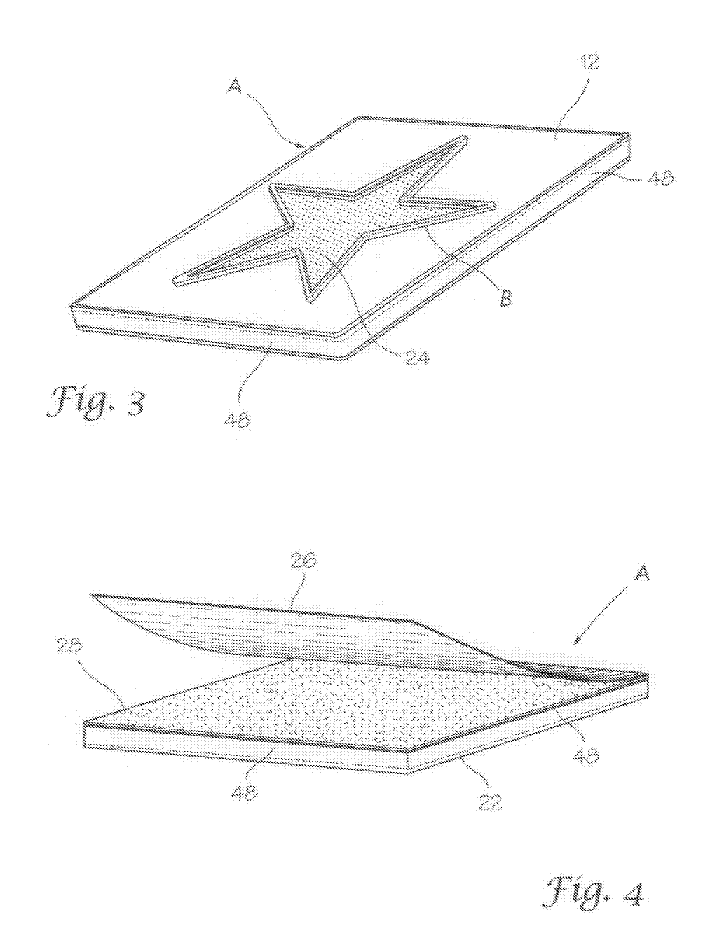

As shown in FIGS. 3 and 4, the sticker stamp unit includes a stencil 22 on a bottom 23 of the unit having one or more stencil cutouts 24. In the illustrated embodiment, the cutout forms a star design. The term design means any imprint that can be formed by a cutout, for example, words, text, graphics representing non-identifiable, identifiable, and distinguished designs such as logos and names of sport teams, public figures (entertainers, artists, politicians, or other individuals, etc.), clothing, colleges, businesses, and other organizations and identities and logos, and tattoos, etc., known and unknown. The top 25 of the sticker stamp unit includes a release liner 26 which is removed to expose an adhesive 28 for application of the unit to the sole of heel of the shoe. Release liner 26 may be a conventional paper or plastic based carrier material, which is coated on one or two sides with a release agent, which provides a release effect against any type of a sticky material such as an adhesive or mastic. Release is separation of the liner from a sticky material. A liner is the carrier for the release agent.

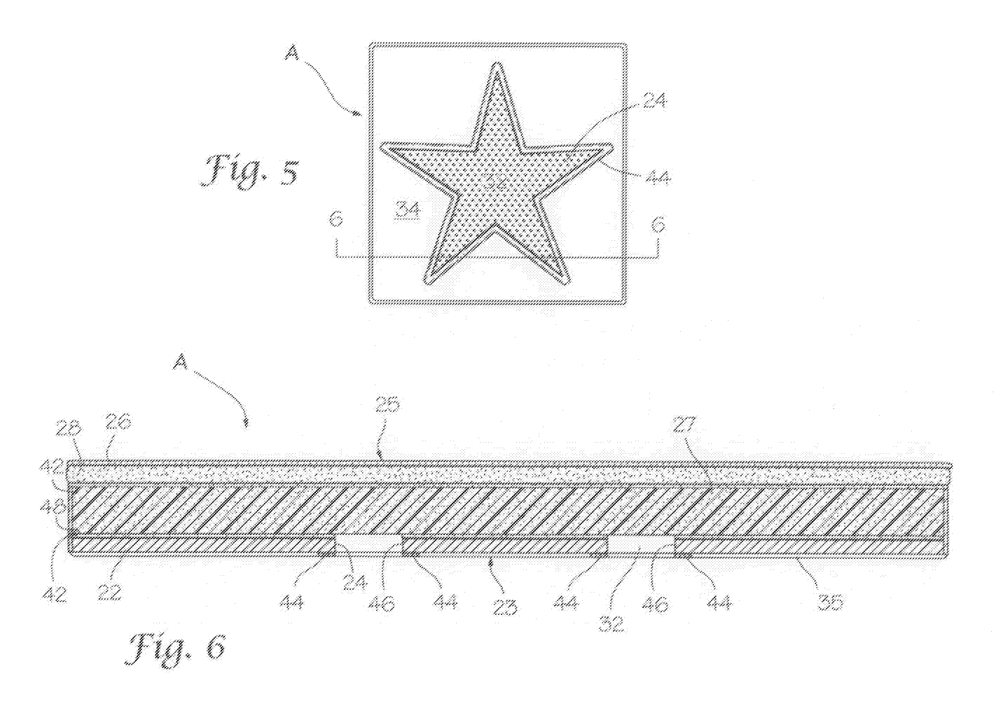

As can best be seen in FIGS. 5 and 6, stencil 22 includes a thin sheet or layer of material 30, such as paper, plastic or metal, with at least one design cutout 24 cut from it so that the design is reproduced on an underlying surface by applying ink pigment 27 through the cutouts 24 in the stencil. The stencil can be reused to repeatedly and rapidly imprint the design. The stencil is made to be reusable. The stencil system allows custom designs for special events and provides a media easy to modify as opposed to rubber stamps. The stencil can be cut by a manual stamp machine, an automated process, or even by hand tools, such as a blade or scissors. This is helpful tp penetrate markets quickly and also to include sponsors or marketing To be reusable, it must remain intact after a design is produced and the stencil is removed from the work surface. This is done by connecting stencil islands 32 (sections of material that are inside cut out “holes” in the stencil) to other parts of the stencil with bridges 34 (narrow sections of material that are not cut out).

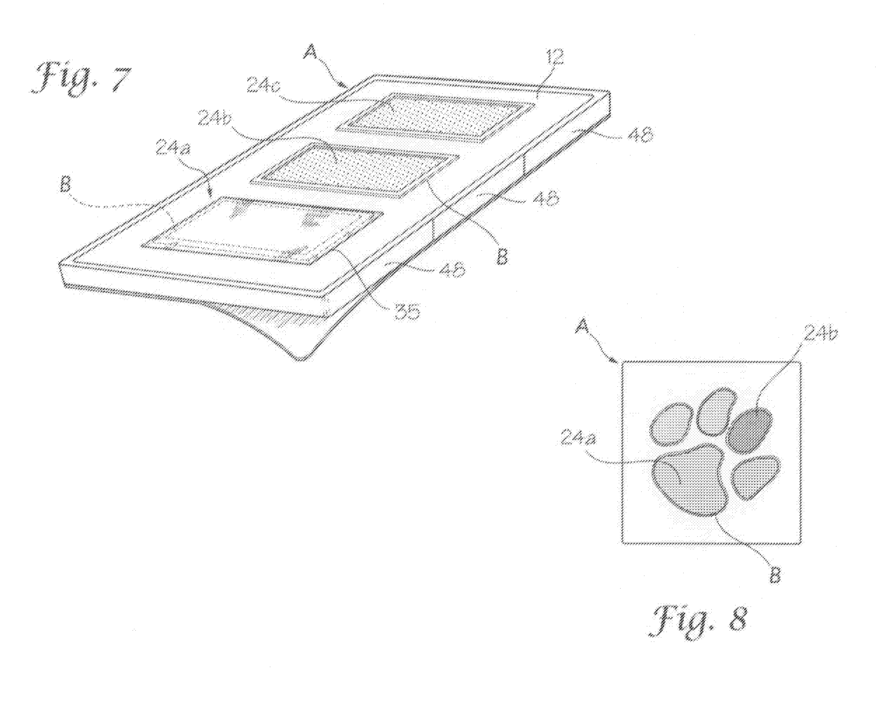

In order to prevent the ink from drying before use, a stencil cover 35 is provided to prevent air from drying the ink. Stencil cover 35 may be provided by a static, sticky or other cover over the stencil (FIG. 6), or over just the cutouts (FIG. 7), or be provided by packaging wrapping the whole unit (FIG. 10).

FIG. 6 illustrates a cross-section to show the various layers of the ink sticker stamp unit. The top layer is release liner 26 which covers and protects adhesive layer 28. The adhesive layer is adhered to the release liner and an ink reservoir and ink application layer 40. The ink application layer may be any suitable material for holding and applying ink when the individual steps and places pressure upon a suitable surface. For example, the layer may be a fibrous pad, sponge, foam, or other ink retaining and dispensing material. An adhesive layer 42 adheres the ink application layer 40 to stencil 22. It will be noted that the adhesive layer is applied only to bridges 34 of the stencil and not over cut out holes 32. Any suitable adhesive may be used as the affixing means of layer 28 and the securing means of layer 42.

Ink seals 44 are disposed about edges 46 of the stencil cutouts 24 to prevent the ink from bleeding onto the stencil bridge surfaces and smearing the design on the surface. The seals may be made from any impervious resilient material, solid or hollow, such as rubber, silicon, or thermoplastic material. Stamp unit A includes impervious sides 48 surrounding the unit so than no ink seeps outwardly from the unit.

When attached by adhesive to the bottom of a shoe it creates an image or a variety of images as a person walks on hard surfaces, such as horizontal sidewalks or paths, pavement, etc. When attached to a fixture or tool, such as a wood block, steel plate, or plastic plate with a handle or roller, the disposable ink pad creates images on hard vertical inclined, or overhead surfaces such as walls or ceilings, as well as any desired hard surface a shoe cannot reach.

As can best be seen in FIG. 7, multi-colored ink pads can be used without cross-contamination by using different colored ink pads 50, 52, 54 above separate stencil cutouts 54, 56, 58. For example, the three different cutouts may imprint the three different colors of a country. There is a glue “shield,” or other impermeable boundary 60 between the separate ink pads to prevent cross-over ink bleeding. Multi-color images are good for many reasons, such as country colors at national events, sport uniform colors, logo recognition, and visual effects.

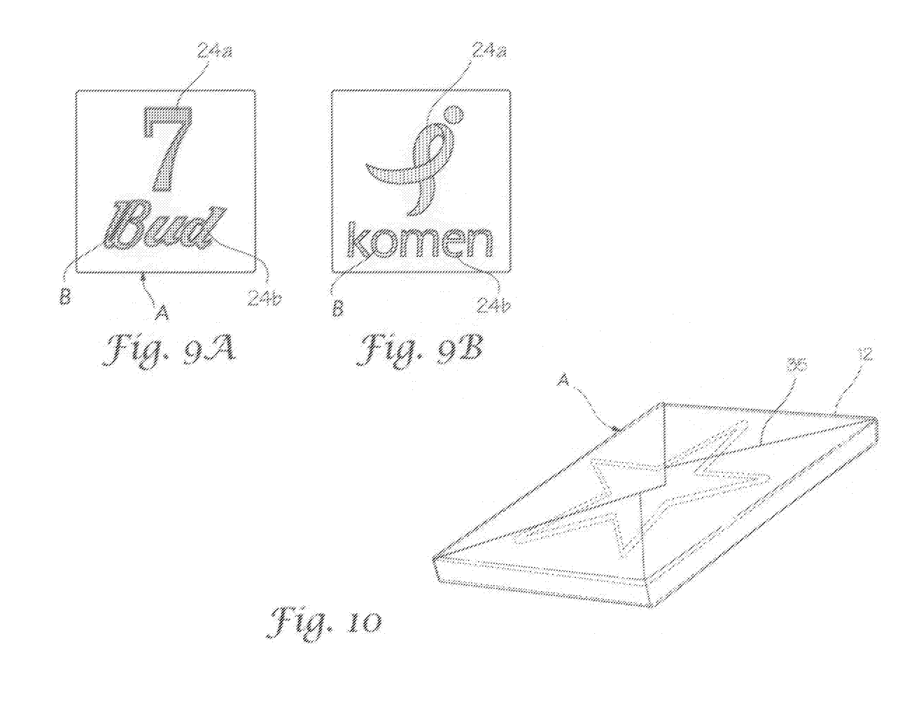

An example is shown in FIG. 8 where a tiger paw print is shown in two colors wherein one toe is blue and the paw and the rest of the toes are orange. Other examples shown in FIGS. 9A and 9B, include a design of racing car #7 sponsored by Budweiser, and a design of a pink ribbon and the name Komen used for cancer fund raising marches.

Thus, it can be seen that an advantageous construction can be had for a simple shoe sticker ink stamp which can be purchased and easily adhered to a shoe or hand tool to reproduce a desired printed design as an individual walks along a generally hard surface, or imprinted by a hand tool. The simplistic design and method of attaching to an object or removing from an object has many advantages such as low cost, applied and removed anywhere easily, does not alter appearance of shoe, a child can use it, does not require multiple applications, small packing, easy distribution, no re-fill chambers, no multiple chambers for multi-colored images, easy to personalize, variety of temporary or permanent ink types, variety of stencil designs, and can cheaply and easily be a theme of an event.

While a preferred embodiment of the invention has been described using specific terms, such description is for illustrative purposes only, and it is to be understood that changes and variations may be made without departing from the spirit or scope of the following claims.

1. An ink sticker stamp unit to be carried by a shoe for producing an imprint of a design on a walking surface comprising:
a bottom layer for engaging the surface including a stencil having one or more stencil cutouts corresponding to the design to be printed;
an ink applicator layer affixed to said stencil for applying ink through said stencil cutouts;
an adhesive layer disposed above said ink applicator for adhering said ink applicator and stencil to said shoe so that pressure applied by the shoe upon said ink applicator causes ink to flow through the one or more stencil cutouts to imprint the design on the walking surface while walking.

2. The device of claim 1 including a seal carried by the stencil around perimeter edges of said one or more cutouts to prevent the ink from leaking out onto the stencil as ink is squeezed through the cutouts during walking.

3. The device of claim 2 wherein said seal includes a resilient element carried along the edges of said cutout.

4. The device of claim 3 wherein the resilient element includes one of a solid and hollow strip secured to said stencil around edges of said one or more cutouts.

5. The device of claim 1 including a release liner affixed to said adhesive layer for protection which is removed from the adhesive layer before application to the shoe.

6. The device of claim 1 wherein said stencil includes a plurality of cutouts, and said ink application layer includes a different ink color above each said cutout.

7. The device of claim 1 including an adhesive layer disposed between said ink applicator layer and said stencil, said adhesive layer covering said stencil but not said stencil cutouts.

8. The device of claim 1 including a removable cover which covers at least said one or more stencil cutouts to prevent ink drying before use.

9. The device of claim 1 including impervious sidewalls surrounding at least said ink applicator layer and stencil's outside edges.

10. An ink sticker stamp unit to be applied to a bottom of a shoe for reproducing an imprint of a design while walking comprising:
a bottom stencil layer comprising a stencil having one or more cutouts to produce the design;
an ink applicator layer disposed above said stencil layer for retaining and supplying ink through said stencil cutouts when walking;
securing means for securing said bottom stencil layer and said ink applicator together; and
affixing means for removably affixing said ink applicator layer to a bottom of the shoe.

11. The device of claim 10 including a removable cover which covers at least said one or more stencil cutouts to prevent ink drying before use.

12. The device of claim 10 wherein said securing means includes an adhesive layer disposed between said ink applicator layer and said stencil, said adhesive layer covering only said stencil and not said stencil cutouts.

13. The device of claim 10 including a seal carried by the stencil around perimeter edges of said one or more cutouts to prevent the ink from seeping onto the stencil as ink is squeezed through the cutouts during walking.

14. The device of claim 10 including a release liner which is removable for affixing said ink applicator to said shoe bottom.

15. An ink sticker stamp unit to be carried by a shoe for producing an imprint of a design on a walking surface comprising:
a bottom stencil having one or more stencil cutouts corresponding to the design to be printed;
an ink applicator disposed above said stencil for applying ink through said stencil cutouts;
an adhesive layer disposed above said ink applicator for affixing said ink applicator to said shoe so that pressure applied by the shoe on said ink applicator while walking causes ink to flow through the stencil cutout to imprint the design on the walking surface.

16. The device of claim 15 including a seal carried by the stencil around perimeter edges of said one or more cutouts to prevent the ink from seeping onto the stencil as ink is squeezed through the cutouts during walking.

17. The device of claim 16 wherein said seal includes a resilient element which includes one of a solid and hollow strip secured to said stencil around edges of said one or more cutouts.

18. The device of claim 15 including an adhesive layer disposed between said ink applicator layer and said stencil wherein said adhesive layer does not cover the stencil cutouts.

19. The device of claim 15 wherein said ink application layer includes a plurality of different color ink pads, said stencil includes a plurality of cutouts, and each said cutout is associated with an ink pad of different color so that a plurality of different colored imprints are reproduced in the design on the surface.

20. The device of claim 15 including a removable cover overlaying at least said one or more cutouts to prevent said ink from drying.

21. An ink sticker stamp unit for producing multiple imprints of a design on a surface comprising:
a bottom layer for engaging the surface including a stencil having one or more stencil cutouts corresponding to the design to be printed;
an ink applicator layer affixed to said stencil for applying ink through said one or more stencil cutouts;
an adhesive layer affixed to said ink applicator layer for adhering said ink applicator to a tool so that pressure applied by the tool upon said ink applicator causes ink to flow through said one or more stencil cutouts to imprint the design on the surface; and
a removable cover overlying said one or more cutouts to prevent the ink from drying.

22. The device of claim 20 including a seal carried by the stencil around perimeter edges of said one or more cutouts to prevent the ink from leaking out onto the stencil as ink is squeezed through the cutouts when printing.

23. The device of claim 20 wherein said ink application layer includes a plurality of different color ink pads, said stencil includes a plurality of cutouts, and each said cutout is associated with an ink pad of different color so that a plurality of different colored imprints are reproduced in the design on the surface.

24. The device of claim 22 including an impermeable boundary disposed between each of said different color ink pads.

25. The device of claim 20 wherein said seal includes a resilient element carried along the edges of said cutout.

26. The device of claim 20 including a release liner affixed to said adhesive layer for protection which is removed from the adhesive layer before application to the tool.

27. The device of claim 20 including an adhesive layer disposed between said ink applicator layer and said stencil, said adhesive layer covering the stencil but not said one or more cutouts.

28. A method of producing imprints of a design while walking on a ground surface and the like comprising the steps of:
providing an ink stamp sticker having an upper adhesive layer, a bottom stencil having stencil cutouts corresponding to the design, and a source of ink disposed between said adhesive layer and stencil;
affixing said stamp sticker to said bottom of said shoe so that said stencil is exposed to the ground surface; and
walking with said stamp sticker affixed to said shoe to apply ink through the cutouts and reproduce imprints of the design on the surface.
